(19) United States
(12) Patent Application Publication
(10) Pub. No.: US 2015/0174752 A1
(43) Pub. Date: Jun. 25, 2015

(54) CONNECTING STRUCTURE-CONTAINED CONNECTION DEVICE OF ELECTRIC TOOL FOR CONNECTION WITH ANGLE ADJUSTER

(71) Applicant: Metabowerke GmbH, Nuertingen (DE)

(72) Inventors: Zhengguo Lu, Shanghai City (CN); Wei Wang, Shanghai City (CN); Rui Wu, Shanghai City (CN); Lidong Xu, Shanghai City (CN); Yiqian Zhang, Shanghai City (CN)

(73) Assignee: Metabowerke GmbH, Nuertingen (DE)

(21) Appl. No.: 14/576,750

(22) Filed: Dec. 19, 2014

(30) Foreign Application Priority Data
Dec. 19, 2013 (CN) 201320842019.1

(51) Int. Cl. B25F 5/00; B23B 31/00

(52) U.S. Cl. CPC B25F 5/00; F16D 3/24

(57) ABSTRACT

A connecting structure-contained connecting device of an electric tool for connection with an angle adjuster, comprises a tooth-shaped jacket which is internally equipped with a locking body, a steel ball, a spring and a spring base; the locking body is connected to the spring base through the spring. When the spring on the spring base is pushed to extend to extrude the steel ball, the axial fixation of the angle adjuster can be quickly and conveniently realized through the connecting device.

### CROSS REFERENCE TO RELATED APPLICATION

Priority is hereby claimed under 35 U.S.C. §119 to co-pending, commonly owned, Chinese application Serial No. 201320842019.1 entitled “CONNECTING STRUCTURE-CONTAINED CONNECTION DEVICE OF ELECTRICAL TOOL FOR CONNECTION WITH ANGLE ADJUSTER” which was filed in China on Dec. 19, 2013, now Chinese Utility Model No. CN 203665475U.

### INCORPORATION BY REFERENCE

Chinese application Serial No. 201320842019.1 entitled “CONNECTING STRUCTURE-CONTAINED CONNECTION DEVICE OF ELECTRICAL TOOL FOR CONNECTION WITH ANGLE ADJUSTER” filed Dec. 19, 2013, is hereby expressly incorporated by reference herein in its entirety to form a part of the present disclosure.

### FIELD OF THE INVENTION

The invention relates to a uniform connecting structured-contained connecting device of an electric tool, which can realize quick stepless connection with an angle adjuster and actuate the angle adjuster to rotate conveniently and freely.

### BACKGROUND OF THE INVENTION

At present, the major of the connecting devices of electric tools for connection with the angle adjuster is a set including an axial fixing device and a connecting sleeve. Those two parts together realize axial fixation and rotation angle of the angle adjuster. However, the connecting sleeve is required to be located and fastened at a correct angle in use, while the angle adjuster is required to be rotated by a big force to make a turn. Besides, the whole operation process wastes time and labor when those two parts are used in combination, causing great inconvenience to use of the angle adjuster.

### BRIEF SUMMARY

The invention relates to a connecting structure-contained connecting device of an electric tool for connection with the angle adjuster, integrating the axial fixing device and the rotating structure into a new whole unit. Such whole unit can realize operations of connecting and rotating the angle adjuster conveniently and quickly. The above mentioned aim is realized in the following way: an input shaft component at the front of the angle adjuster is provided with a spring base, and the locking body on the connecting mechanism can be conveniently and quickly fastened with the electric tool when a spring on the spring base extends to extrude a steel ball on a locking body, thus ensuring the axial fixation of the angle adjuster. Then, those structures all are installed in a main stepless tooth-shaped jacket of the connecting device. The tooth profiles distributed on the tooth-shaped jacket can guide the connecting device to be easily engaged with the corresponding tooth profiles on the electric tool. The connection is realized without careful alignment of angles, and the process of rotating the angle adjuster makes simpler and more convenient.

Disclosed is a connecting device for integrating axial fixation and rotation operation of the angle adjuster. Such integrated connecting device saves materials and space, makes operation and use of the angle adjuster on the electric tool quicker and more convenient, and can improve efficiency of use.

### BRIEF DESCRIPTION OF THE DRAWINGS

FIG. 1 is an overall structural view of the connecting device.

FIG. 2 is a schematic view of connection between the connecting device and the angle adjuster.

FIG. 3 is an overall connection view.

### DETAILED DESCRIPTION

To solve a series of complicated operation problems of a connecting device of an electric tool for connection with the angle adjuster. An integrated connecting device consists of a tooth-shaped jacket 1, a locking body 2, a steel ball 3, a spring 4 and a spring base 5, wherein the tooth-shaped jacket 1, the locking body 2 and the spring base 5 are connected by the spring 4 to form an assembly which pushes the spring 4 on the spring base 5 to extend to extrude the steel ball 3 on the locking body 2. The steel ball 3 can quickly and conveniently realize fastening between the locking body 2 of the connecting device and the electric tool to complete axial fixation of the angle adjuster. The locking body 2, the steel ball 3, the spring 4 and the spring base 5 together are installed in the tooth-shaped jacket 1. The tooth profiles of the tooth-shaped jacket 1 can be conveniently engaged with the corresponding tooth profiles of the electric tool through such that the angle adjuster makes a turn conveniently and freely. Adjustment of the rotation angle can be controlled according to the quantity of inner teeth on the tooth-shaped jacket 1 and the interval between teeth. The smaller the interval between the teeth is, the more accurate the angle adjustment is.

The integrated connecting device realizes stepless connection through the tooth profiles of the tooth-shaped jacket and the corresponding tooth profiles on the electric tool, so location and fastening at right angle are completely not required like the connecting sleeve. The more the teeth are, the smaller the rotation angle is required. The dense tooth profiles make the rotation of the angle adjuster more convenient. Besides, the inner locking body can quickly and conveniently realize fastening with the electric tool when the spring extends to extrude the steel ball, thus completing the axial fixation. Through this integrated connecting device, the connection and rotation of the angle adjuster are simpler and more practical. The invention is suitable for massive production and manufacturing and can be widely applied to various electric tools.

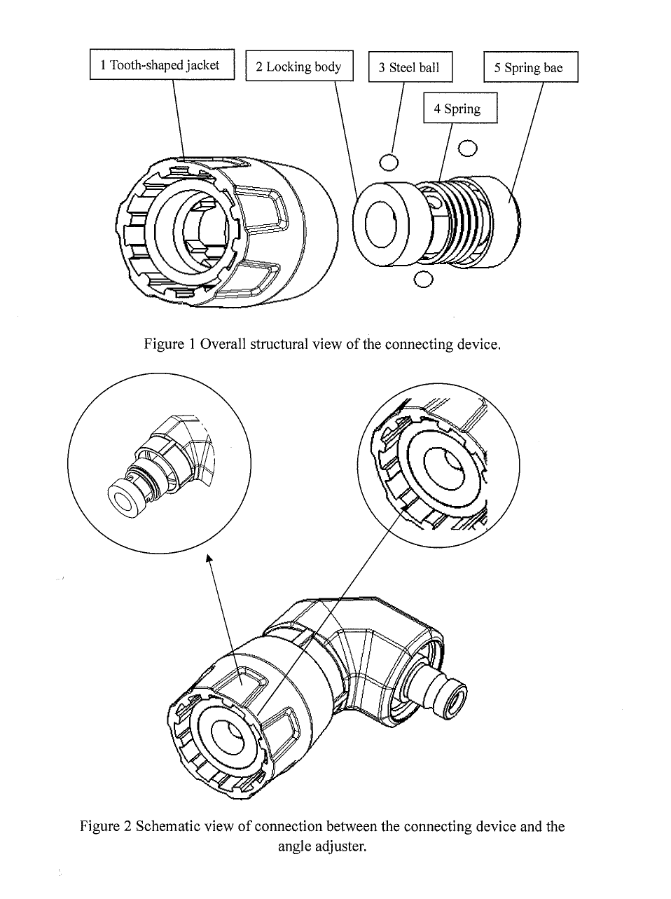

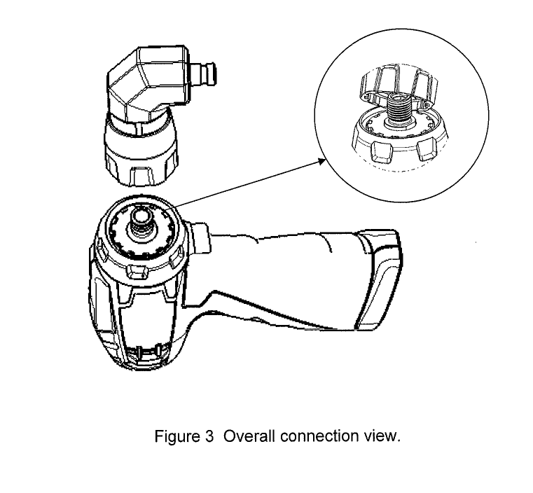

The invention provides an integrated connecting device, as shown in FIG. 1, consisting of a tooth-shaped jacket 1, a locking body 2, a steel ball 3, a spring 4 and a spring base 5. The input shaft component at the front of the angle adjuster is provided with the spring base 5. The locking body 2 is connected to the spring base 5 through the spring 4. The spring 4 on the spring base 5 extends to extrude the steel ball 3. The steel ball 3 realizes extrusion and fastening between the locking body 2 and the electric tool 2 to complete axial fixation. Besides, the locking body 2, the steel ball 3, the spring 4 and the spring base 5 all are located in the tooth-shaped jacket 1 to form an integrated connecting device, and then a bearing is connected with a bevel gear to realize connection between the connecting device and the angle adjuster, as shown in FIG. 2. The connecting device realizes quick stepless connection through engagement between the tooth profiles on the tooth-shaped jacket 1 and those on the electric tool. As shown in FIG. 3, the more the teeth there are, the smaller the rotation angle is required, and the wider the rotation scope of the angle adjuster is. The manufacturer can determine the specific tooth quantity according to the actual needs (The embodiment shown uses 12 teeth as an example, and the minimum rotation angle is 30°). The distributed tooth profiles can easily realize connection between the connecting device and the electric tool, and the angle adjuster can realize free rotation when the spring 4 extrudes the locking body 2 such that the operation of rotating the angle adjuster becomes simpler and more convenient. The connecting device integrating the axial fixing device and the rotating structure simplifies the whole operation process and eliminates incontinences in during connection and rotation of the angle adjuster.

What is claimed is:

1. A connecting structure-contained connecting device of an electric tool for connection with an angle adjuster, comprising a tooth-shaped jacket, characterized in that the tooth-shaped jacket is internally equipped with a locking body , a steel ball, a spring and a spring base; the locking body is connected to the spring base through the spring; and when the spring on the spring base is pushed to extend to extrude the steel ball, the axial fixation of the angle adjuster can be quickly and conveniently realized through the connecting device.

2. The connecting structure-contained connecting device of an electric tool for connection with an angle adjuster according to claim 1, wherein the connecting device realizes stepless connection through engagement between the tooth profiles on the tooth-shaped jacket and those on the electric tool; the quantity of teeth can be determined upon needs; the more the teeth there are, the smaller the rotation angle is required, and the wider the rotation scope of the angle adjuster is.

3. The connecting structure-contained connecting device of an electric tool for connection with an angle adjuster according to claim 1, wherein the axial fixing device (locking body, steel ball , spring and spring base) and the rotating structure (tooth-shaped jacket) are integrated as a whole, effectively simplifying the whole operation and use process of the angle adjuster.
